(19) United States
(12) Patent Application Publication
(10) Pub. No.: US 2012/0020010 A1
(43) Pub. Date: Jan. 26, 2012

(54) NOTEBOOK COMPUTER HOUSING STRUCTURE

(76) Inventor: Chia-Cheng CHANG, Taipei County (TW)

(21) Appl. No.: 12/841,415

(22) Filed: Jul. 22, 2010

(51) Int. Cl. G06F 1/20

(52) U.S. Cl. 361/679.46

(57) ABSTRACT

A notebook computer housing structure is described. The notebook computer housing structure includes a body, which is made of one of plastic, aluminum, and an aluminum magnesium alloy. A circuit board installed with electronic elements such as a CPU and an interface card is placed inside the body. The improvement lies in that a plurality of holes is disposed on the body to form a convection effect inside the body after cold air enters the body through the holes.

### BACKGROUND OF THE INVENTION

1. Field of the Invention

The present invention relates to a notebook computer housing structure that is low in cost and can effectively reduce the internal temperature of a notebook computer.

2. Related Art

In recent years, the computer industry has been developed rapidly. Computers, especially notebook computers, are required to be fully equipped and run fast, and the overall structure should be light, thin, short, and small; moreover, they are desired to be dazzling, beautiful, and unique in appearance. Having the characteristics of being light, hard to rust, easy to process, and convenient for installation, the aluminum alloy has been widely used as the material of housings of 3C products, especially housings of notebook computers and mobile phones. Since the housing is the most direct method for protecting such commodities, the aluminum alloy housing is usually combined with a plastic material having high heat resistance, stability, and processing fluidity to enhance its hardness, and thus its excellent performance is maintained.

However, although the above effects can be achieved by adopting the above notebook computer housing, the heat generated by internal electronic elements in high-speed operation cannot be effectively dissipated. Even with the assistance of a fan and heat dissipation fins, the temperature can only be maintained at about 50-60 degrees. In order to achieve a better heat dissipation effect, the cost of the overall heat dissipation system (such as the fan, the fins, and even a duct heater) has to be increased. In this regard, effectively reducing the internal temperature of the notebook computers and the cost has been the research direction of the inventor.

### SUMMARY OF THE INVENTION

The primary object of the present invention is to provide a notebook computer housing structure that is low in cost and can effectively reduce the internal temperature of a notebook computer.

To achieve the aforementioned object, the present invention provides a notebook computer housing structure, which includes a body. The body is made of one of plastic, aluminum, and an aluminum magnesium alloy. A circuit board installed with electronic elements such as a CPU and an interface card is placed inside the body. The improvement lies in that a plurality of holes is disposed on the body to form a convection effect inside the body after cold air enters the body through the holes.

In practice, the holes of the body are provided with screw threads.

In practice, the holes of the body are tapered, so that an aperture of the holes outside the body is larger than an aperture inside the body, and the holes of the body may be designed to have screw threads.

Other objects, advantages and novel features of the present invention will become more apparent from the following detailed description when taken in conjunction with the accompanying drawings.

### BRIEF DESCRIPTION OF THE DRAWINGS

FIG. 1 is a schematic outside view of a notebook computer housing structure according to an embodiment of the present invention;

FIG. 2 is a schematic view of a use state of the notebook computer housing structure according to the embodiment of the present invention;

FIG. 3 is a schematic partial view of a hole on a body in the embodiment of the present invention;

FIG. 4 is a schematic partial view of the hole provided with screw threads on the body in the embodiment of the present invention; and

FIG. 5 is schematic partial view of the hole designed to be tapered in the embodiment of the present invention.

### DETAILED DESCRIPTION OF THE INVENTION

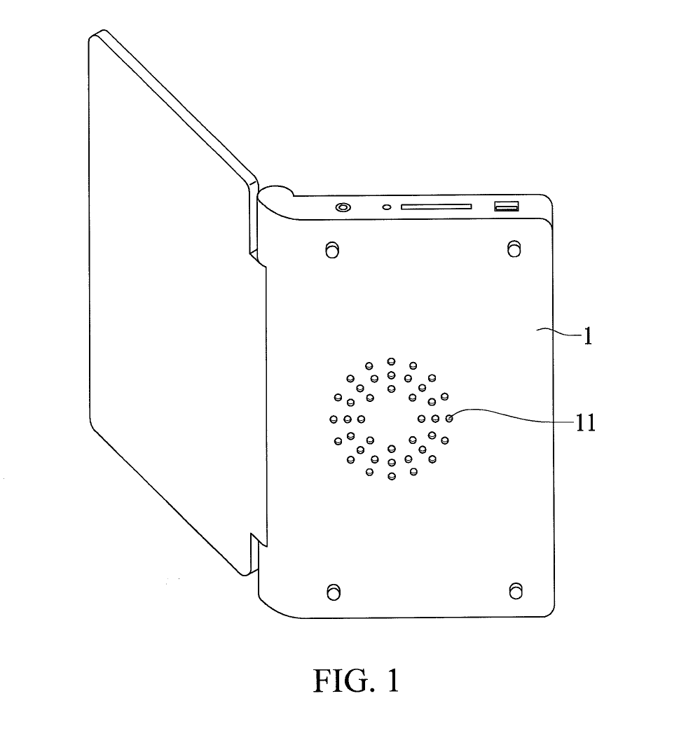

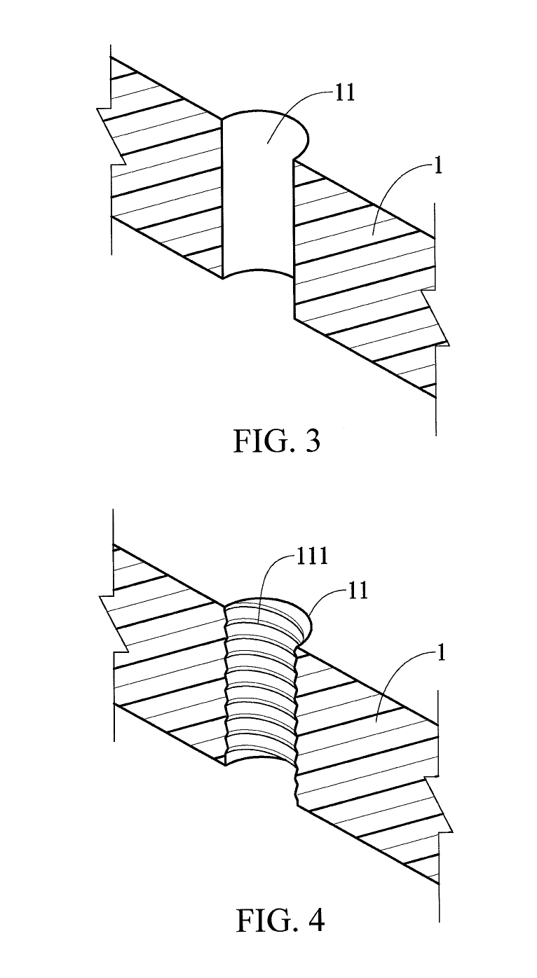

FIG. 1 to FIG. 4 show a preferred embodiment of a notebook computer housing structure according to the present invention. Referring to FIG. 1 to FIG. 4, the notebook computer housing structure of the present invention includes a body 1, which is made of one of plastic, aluminum, and an aluminum magnesium alloy.

A circuit board installed with electronic elements such as a CPU 2 and an interface card is placed inside the body 1. A plurality of holes 11 is disposed on the body 1. The holes 11 of the body 1 may be designed to have screw threads 111.

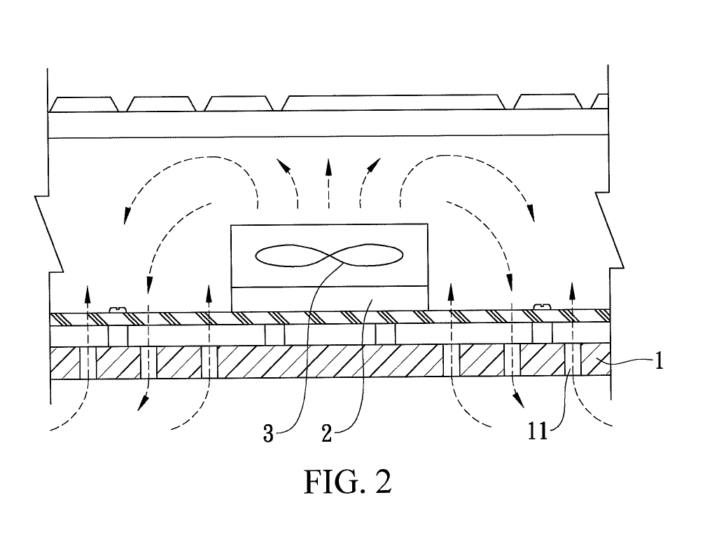

Therefore, in the implementation, as shown in FIG. 2, the heat generated when the internal electronic elements of a notebook computer such as a display card and the CPU 2 start can be removed through a fan 3 or heat dissipation fins. Meanwhile, with the plurality of holes 11 disposed on the body 1 of the present invention, cold air outside the notebook computer forms a convection effect inside the body 1 after entering the body through the holes 11.

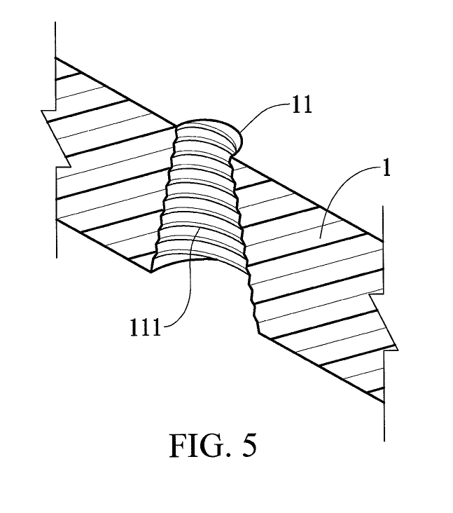

Moreover, as shown in FIG. 5, the holes 11 of the body 1 may be tapered, so that an aperture of the holes 11 outside the body 1 is larger than an aperture inside the body 1, and the holes 11 of the body 1 may be designed to have screw threads 111, so that pressure can be increased to enhance the convection effect when cold air enters the body through the holes 11.

The above description is a specific embodiment of the present invention and the employed technical means. Various variations and modifications can be made based on the disclosure or teachings of this text. Any equivalent changes made based on the concept of the present invention having their effect without departing from the spirit encompassed by the specification and the drawings should be construed as falling within the technical scope of the present invention.

According to the above disclosed contents, the present invention can indeed achieve the intended purpose of providing a notebook computer housing structure, and undoubtedly has industrial applicability and practical value. Thus, the patent application is filed according to the law.

It should be understood that different modifications and variations could be made from the disclosures of the present invention by the people familiar in the art without departing the spirit of the present invention.

What is claimed is:

1. A notebook computer housing structure, comprising:
a body, made of one of plastic, aluminum, and an aluminum magnesium alloy, wherein a circuit board installed with electronic elements including a CPU and an interface card is placed inside the body, wherein
a plurality of holes is disposed on the body, so as to form a convection effect inside the body after cold air enters the body through the holes.

2. The notebook computer housing structure according to claim 1, wherein the holes of the body are provided with screw threads.

3. The notebook computer housing structure according to claim 1, wherein the holes of the body are tapered, so that an aperture of the holes outside the body is larger than an aperture inside the body.

4. The notebook computer housing structure according to claim 3, wherein the holes of the body are provided with screw threads.
